(19) United States
(12) Patent Application Publication
(10) Pub. No.: US 2014/0038000 A1
(43) Pub. Date: Feb. 6, 2014

(54) Flow-Through Metal Battery with Ion Exchange Membrane

(71) Applicant: Sharp Laboratories of America, Inc., Camas, WA (US)

(72) Inventors: Yuhao Lu, Vancouver, WA (US); Jong-Jan Lee, Camas, WA (US); Hidayat Kisdarjono, Vancouver, WA (US)

(73) Assignee: Sharp Laboratories of America, Inc., Camas, WA (US)

(21) Appl. No.: 14/042,264

(22) Filed: Sep. 30, 2013

Related U.S. Application Data
(63) Continuation-in-part of application No. 13/564,015, filed on Aug. 1, 2012.

(51) Int. Cl. H01M 4/36

(52) U.S. Cl. CPC H01M 4/364
USPC 429/51; 429/103; 429/81

(57) ABSTRACT

A metal flow-through battery is provided, with ion exchange membrane. The flow-through battery is primarily made up of an anode slurry, a cathode slurry, and a hydroxide (OH⁻) anion exchange membrane interposed between the anode slurry and the cathode slurry, The anode and cathode slurries are both aqueous slurries. The anode slurry includes a metal, and associated oxides, such as magnesium (Mg), aluminum (Al), iron (Fe), copper (Cu), or zinc (Zn). The cathode slurry includes a chemical agent such as nickel oxyhydroxide (NiOOH), nickel (II) hydroxide (Ni(OH)₂), manganese oxide (MnO₂), manganese (II) oxide (Mn₂O₃), iron (III) oxide (Fe₂O₃), iron (III) oxide (FeO), iron (III) hydroxide (Fe(OH)), or combinations of the above-referenced materials. A method is also provided for forming a voltage potential across a flow-through battery.

### RELATED APPLICATION

The application is a Continuation-in-Part of a pending application entitled, BATTERY WITH LOW TEMPERATURE MOLTEN SALT (LTMS) CATHODE, invented by Yuhao Lu et al., Ser. No. 13/564,015, filed on Aug. 1, 2012, Attorney Docket No. SLA3165;

### BACKGROUND OF THE INVENTION

1. Field of the Invention

This invention generally relates to electrochemical. cells and., more particularly, to a battery formed from aqueous anode and cathode slurries.

2. Description of the Related Art

Flow-through batteries has been intensively studied and developed for large-scale energy storage due to their long cycle life, flexible design, and high reliability. A battery is an electrochemical device in which ions (e.g. metal-ions, hydroxyl-ions, protons, etc.) commute between the anode and cathode to realize energy storage and conversion. In a conventional battery, all the components including anode materials, cathode materials, separator, electrolyte, and current collectors are packed into a volume-fixed container. Its energy and capacity of are unchangeable as long as the battery is assembled. A flow-through battery consists of current collectors (electrodes) separated by an ion exchange membrane, while its anode and cathode materials are stored in separate storage tanks. The anode and cathode materials are circulated through the flow-through battery in which electrochemical reactions take place to deliver and to store energy. Therefore, the battery capacity and energy are determined by (1) electrode materials (anolyte and catholyte), (2) the concentrations of anolyte and catholyte, and (3) the volumes of anolyte and catholyte storage tanks.

Conventional state-of-the-art anode and cathode materials typically involve an aqueous or non-aqueous solution containing some redox couples [1]. One typical flow-through battery is an all vanadium redox flow battery (VRB) in which the VO₂⁺/VO²⁺ solution is catholyte and V²⁺/V³⁺ solution is anolyte. The battery works in the voltage range of 1.15-1.55 V. However, it is worth noting that the VRB capacity is determined by the redox couple concentrations of catholyte and anolyte. In general, the concentration of vanadium and total H₂SO₄ is less than 2 moles (M) and 5M, respectively [2]. So, in terms of VRB voltage and capacity, its specific energy is 15 Wh/kg. In order to increase the specific energy, two approaches can he used. One is to increase the work potential of the battery. In non-aqueous electrolyte, the standard voltage of VRB can be increased to 2.2 V with vanadium acetylacetonate redox couple. The other method is to increase the concentrations of redox couples in catholyte/anolyte.

The concentrations of redox couples in the electrolyte are determined by their solubility. Even through many efforts have been made, the maximum vanadium centration is only 3M. In 2011, Carter and Chiang [3] disclosed the use of a flowable semi-solid composition (slurry) as the catholyte and anolyte in flow-through batteries with an organic electrolyte. The slurries concentrations are not limited by their solubility, which provides a very high capacity for the flow-through batteries. However, there exists a safety issue because of the flammable organic electrolyte.

[1] A. Z. Weber, M. M. Mench, J. P. Meyers, P. N. Ross, J. T. Gostick, Q. Liu, Redox flow batteries: a review, J. Appl. Electrochem, 41(2011)1137-1164.

[2] Z. Yang, J. Zhang, M. C. W. Kintner-Meyer, X. Lu, D. Choi, J. P. Lemmon, J. Liu, Electrochemical energy storage for green grid, Chemical review, 111(2011)3577-3613.

[3] William C. Carter, Yet-Ming Chiang, High energy density redox flow device, US 2011/0189520 A1.

It would be advantageous if a flow-through battery existed with catholyte and anolyte slurries that used a non-flammable electrolyte.

### SUMMARY OF THE INVENTION

A flow-through metal battery (FMB) with aqueous electrolyte is described herein. In general, metals have very high capacities due to their small molecular weight. For instance, the theoretical capacity for aluminum is 2980 milliamp-hours per gram (mAh/g), while zinc is 820 mAh/g, and iron is 960 mAh/g. With a high concentrated metal-slurry anolyte, a FMB can deliver much higher capacity than an all vanadium reflux flow battery (VRB). Furthermore, the use of a metal anolyte slurry in an aqueous electrolyte has many advantages over flow-through batteries using an organic electrolyte, such as: (1) higher power density, (2) economy, (3) safety, and (4) flexible deployment.

The flow-through metal battery consists of a low temperature molten salt (LTMS) slurry-type catholyte and slurry-type anolyte separated by an ion-exchange membrane. The anolyte and catholyte are circulated through the flow-through battery. The active materials in the anolyte are metals or their oxides/hydroxides depending on the charged/discharged state of FMB. The active materials in the catholyte can be any kind of slurry containing redox couples. The anolyte and catholyte are aqueous electrolytes.

Accordingly, a metal flow-through battery is provided, with an ion exchange membrane. The flow-through battery is primarily made up of an anode slurry, a cathode slurry, and a hydroxide (OH⁻) anion exchange membrane interposed between the anode slurry and the cathode slurry. The anode and cathode slurries are both aqueous slurries. The anode slurry includes a metal, and associated oxides, such as magnesium (Mg), aluminum (Al), iron (Fe), copper (Cu), or zinc (Zn). The cathode slurry includes a chemical agent such as nickel oxyhydroxide (NiOOH), nickel (II) hydroxide (Ni(OH)₂), manganese oxide (MnO₂), manganese (II) oxide (Mn₂O₃), iron OM oxide (Fe₂O₃), iron (III) oxide (FeO), iron (III) hydroxide (Fe(OH)₃), or combinations of the above-referenced materials.

More explicitly, the flow-through battery also includes an anode compartment with an anion exchange membrane interface, a first stationary current collector, an input flow port, and an output flow port. Likewise, a cathode compartment has an anion exchange membrane interface, a second stationary current collector, an input flow port, and an output flow port. An anode slurry reservoir is connected to the input and output flow ports of the anode compartment, and a cathode slurry reservoir is connected to the input and output flow ports of the second compartment. In one aspect, the flow-through battery includes a plurality of cells, where each cell includes an anode slurry and a cathode slurry, and where the plurality of cells are connected are is series or parallel electrical configuration.

A method is also provided for forming a voltage potential across a flow-through battery. The method provides an anode slurry and a cathode slurry, separated by a hydroxide (OH⁻) anion exchange membrane. A flow of OH⁻ ions and electrons is generated between the cathode slurry and the anode slurry. As a result, a voltage potential is generated across a load that is electrically connected between the anode slurry and the cathode slurry.

Additional details of the above-described method and flow-through battery are provided below.

### BRIEF DESCRIPTION OF THE DRAWINGS

FIG. 1 is a schematic block diagram depicting a metal flow-through battery with ion exchange membrane.

FIGS. 2A and 2B are schematic block diagrams of a flow-through battery with a plurality of cells.

FIGS. 3A and 3B are partial cross-sectional views of a plurality of cells, enabled as sequential plates, which are electrically connected in series.

FIGS. 4A through 4H are exemplary detailed depictions of the plates of FIG. 3B.

FIGS. 5A and 5B are partial cross-sectional views of a plurality of cells electrically connected in parallel.

FIGS. 6A and 6B are diagrams respectively depicting details of the anode and cathode current collectors of FIG. 2A or 2B.

FIG. 7 is a flowchart illustrating a method for forming a voltage potential across a flow-through battery.

### DETAILED DESCRIPTION

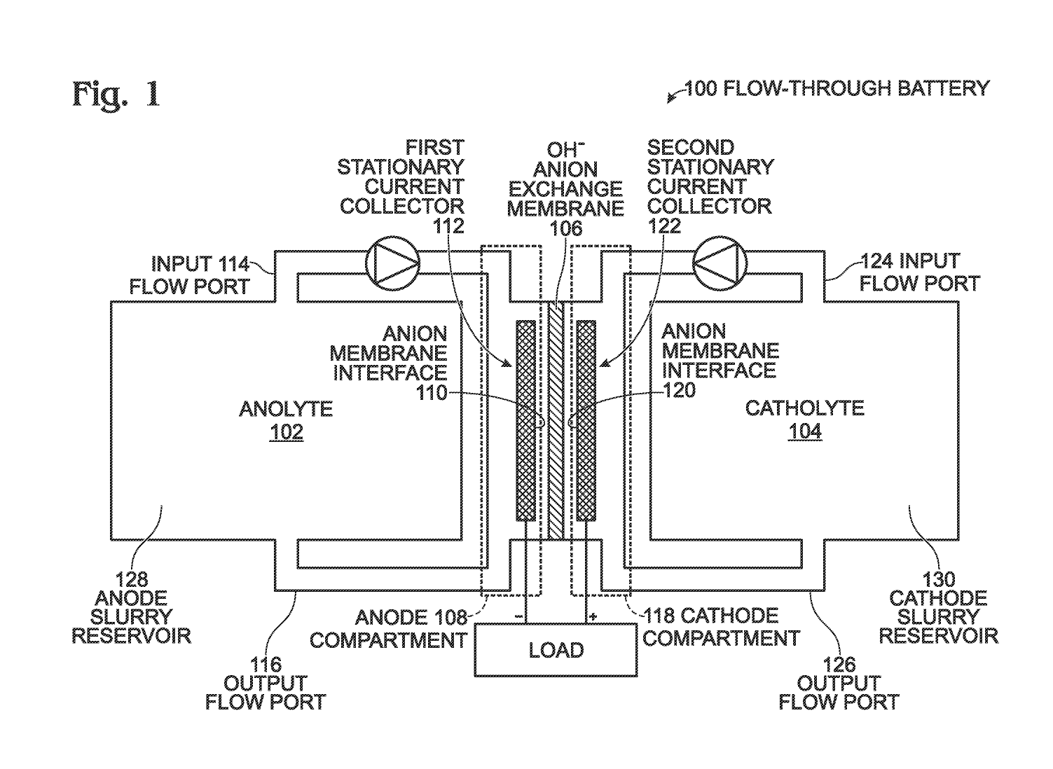

FIG. 1 is a schematic block diagram depicting a metal flow-through battery with ion exchange membrane. The flow-through battery 100 comprises an anode slurry 102, a cathode slurry 104, and a hydroxide (OH⁻) anion exchange membrane 106 interposed between the anode slurry and the cathode slurry. One example of an (OH⁻) anion exchange membrane is the anion conductive membrane manufactured by Tokuyama. Both the anode slurry 102 and cathode slurry 104 are aqueous slurries. Thus, the battery can be said to use an aqueous electrolyte. The anode slurry 102 is typically comprised of a metal such as magnesium (Mg), aluminum (Al), iron (Fe), copper (Cu), or zinc (Zn). Alternatively, or in addition, the anode slurry 102 may be comprised of oxides of the above-listed metals. The cathode slurry 104 typically includes a chemical agent such as nickel oxyhydroxide (NiOOH), nickel (II) hydroxide (Ni(OH)₂), manganese oxide (MnO₂), manganese (II) oxide (Mn₂O₃), iron (III) oxide (Fe₂O₃), iron (III) oxide (FeO), iron (III) hydroxide (Fe(OH)₃), or combinations of the above-referenced materials. In one aspect, the anode slurry 102 and cathode slurry additionally include potassium hydroxide (KOH).

In more detail, the flow-through battery 100 further comprises an anode compartment 108 with an anion exchange membrane interface 110, a first stationary current collector 112, an input flow port 114, and an output flow port 116. Likewise, the flow-through battery 100 comprises a cathode compartment 118 with an anion exchange membrane interface 120, a second stationary current collector 122, an input flow port 124, and an output flow port 126. An anode slurry reservoir 128 is connected to the input flow port 114 and output flow port 116 of the anode compartment 108. A cathode slurry reservoir 130 is connected to the input flow port 124 and output flow port 126 of the cathode compartment 118.

Such a flow-through battery 100 is completely charged and discharged in a voltage potential range of 0 to 2.5 volts. That is, a single battery cell, with one anode and one cathode, has a voltage potential range of 0 to 2.5 volts. However, as explained below, a flow-through. battery may be comprised of a plurality of cells.

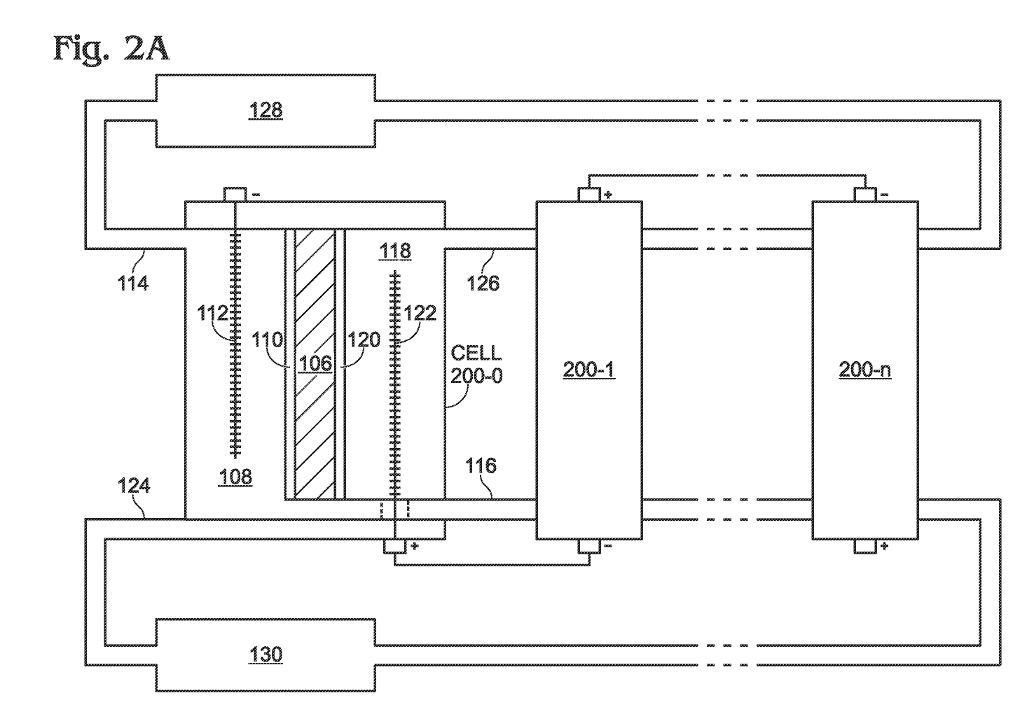

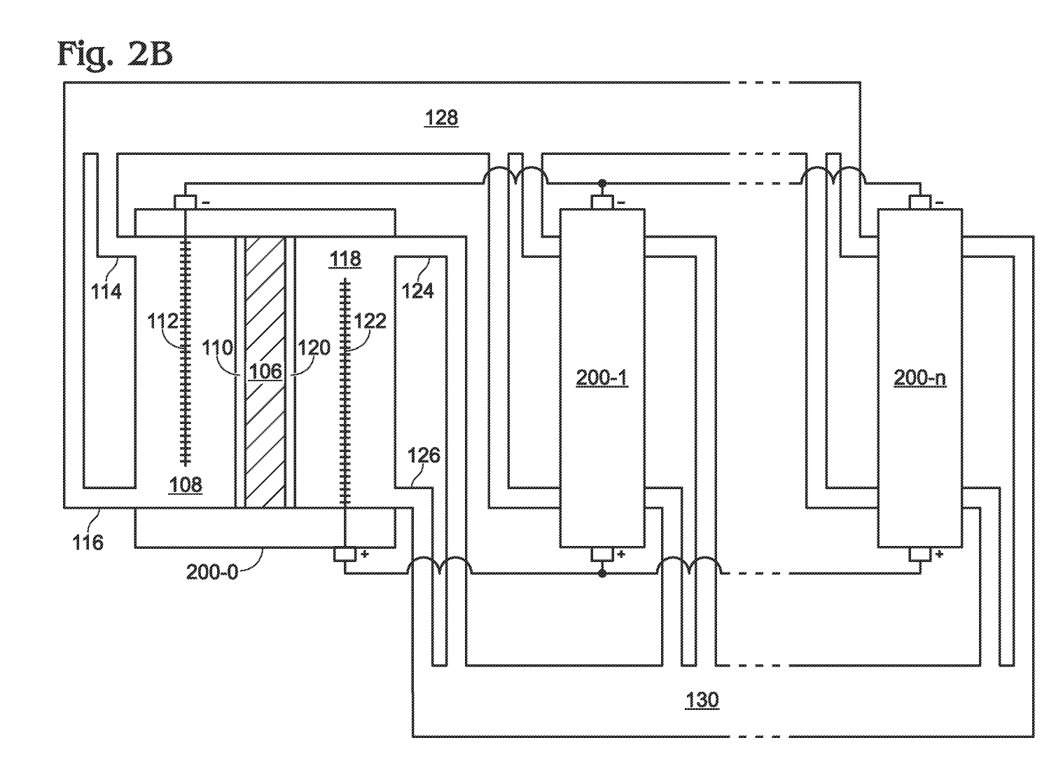

FIGS. 2A and 2B are schematic block diagrams of a flow-through battery with a plurality of cells. Each cell, 200-0 through 200-n, includes an anode slurry 102 and a cathode slurry 104. In other words, the battery shown in FIG. 1 may he referred to as a cell. As shown in FIG. 2A, the plurality of cells 200-0 through 200-n may be connected in a configuration of series electrical connections. As shown in FIG. 2B, the plurality of cells 200-0 through 200-n may be in the configuration of parallel electrical connections.

Using cell 200-0 of FIG. 2A as a representative, each cell further comprises an anode compartment 108 with an anion exchange membrane interface 110, a first stationary current collector 112, an input flow port 114, and an output flow port 116. Each of the cells 200-0 through 200-n also comprises a cathode compartment 118 with an anion exchange membrane interface 120, a second stationary current collector 122, an input flow port 124, and an output flow port 126.

In FIG. 2A, the anode slurry reservoir 128 is connected in series (slurry-wise) to the plurality of anode compartments, and the cathode slurry reservoir 130 is connected in series (slurry-wise) to the plurality of cathode compartments. Alternatively, as shown in FIG. 2 the anode slurry reservoir 128 is connected in parallel (slurry-wise) to the plurality of anode compartments, and the cathode slurry reservoir 130 is connected in parallel (slurry-wise) to the plurality of cathode compartments. However, it should he understood that the plurality of cells may he connected electrically in series, while being connected in parallel slurry-wise. Likewise, the plurality of cells may he connected electrically in parallel, while being connected in series slurry-wise.

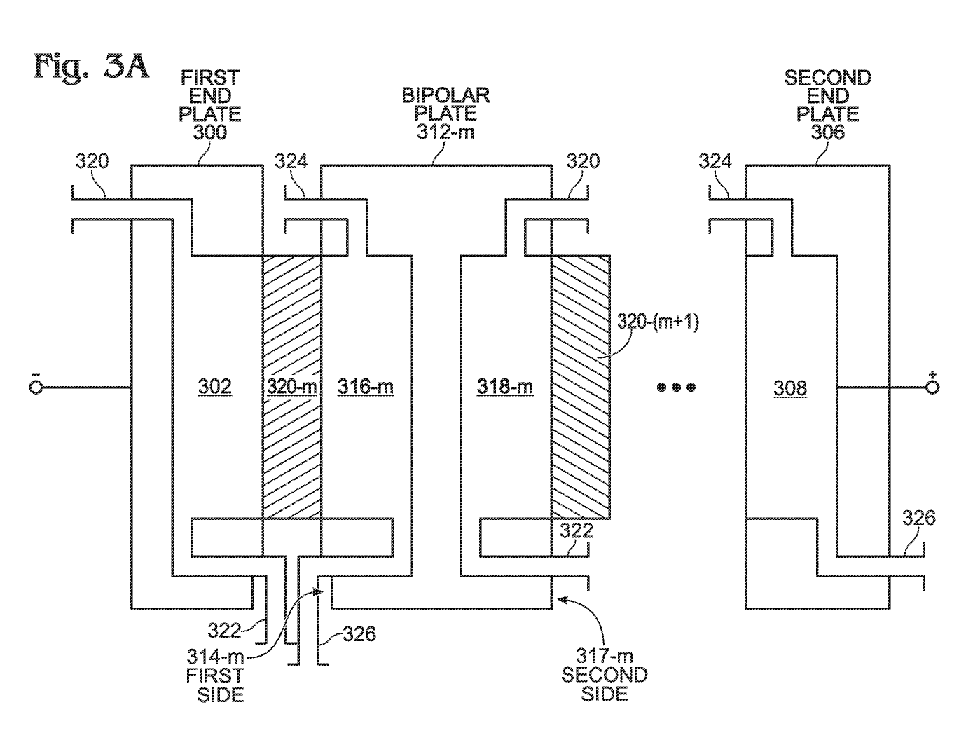

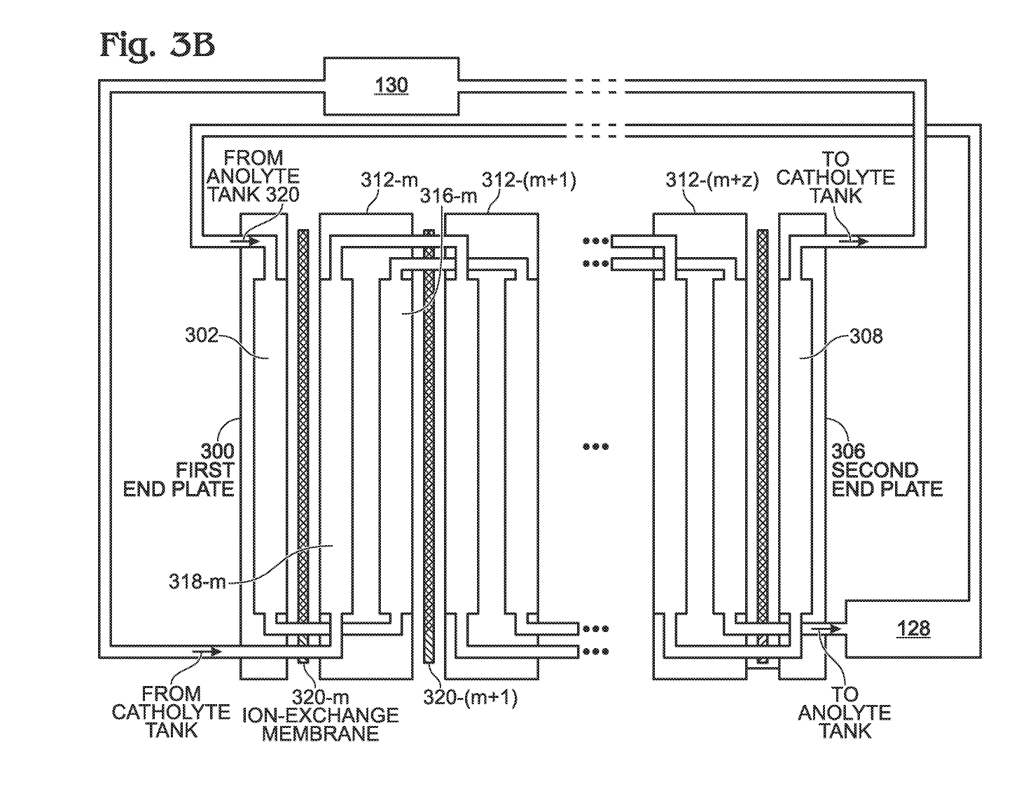

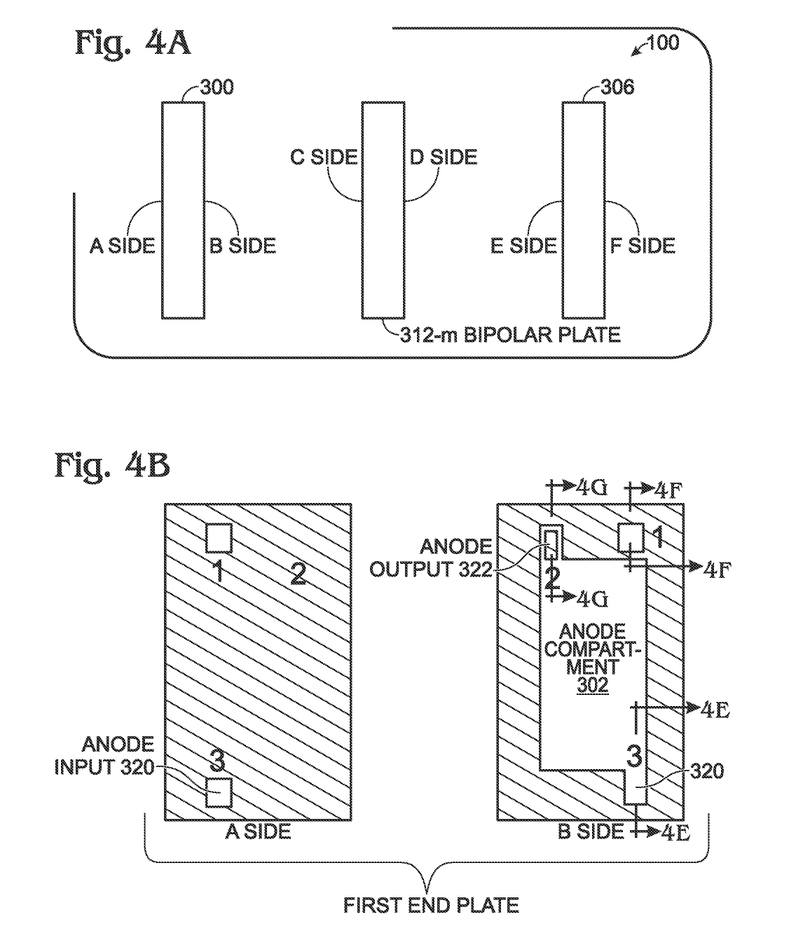

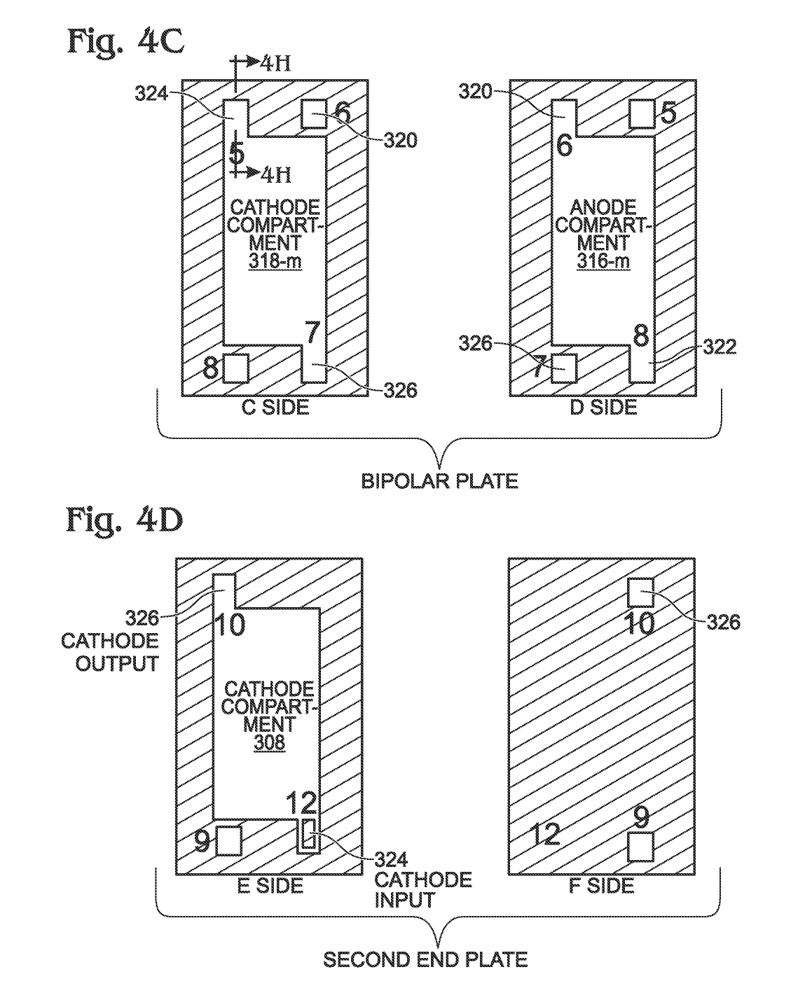

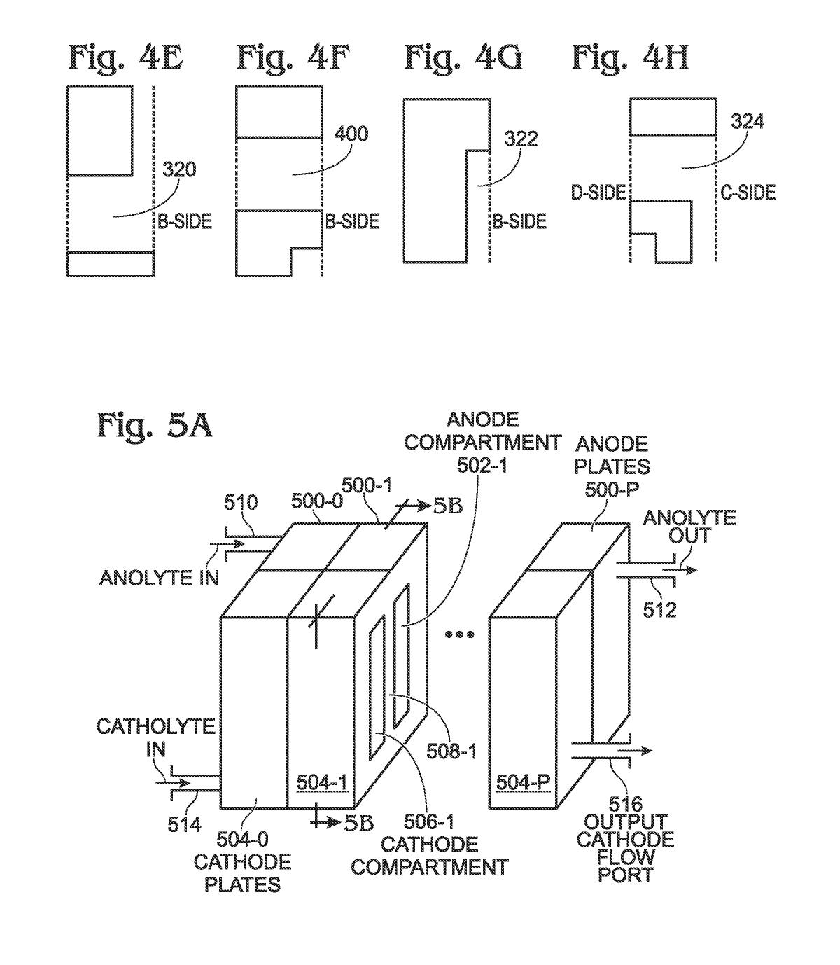

FIGS. 3A and 3B are partial cross-sectional views of a plurality of cells, enabled as sequential plates, which are electrically connected in series. An electrically conductive first end plate 3(X) comprises an anode compartment 302. An electrically conductive second end plate 306 comprises a cathode compartment 308. At least one electrically conductive bipolar plate 312-m (m is an integer≧1) is configured between the first plate 300 and second end plate 306. Each bipolar plate, as represented by bipolar plate 312-m, comprises a first side 314-m (C in FIG. 4A) with a cathode compartment 316-m and a second side 317-m (D in FIG. 4A) with an anode compartment 318-m. An OH⁻ anion exchange membrane is interposed between each plate 300, 306, and 312-m. Shown are OH⁻ anion exchange membranes 320-m and 320-(m+1).

The first end plate 300 and each bipolar plate, as represented by bipolar plate 312-m, comprise an anode input flow port 320 and an anode output flow port 322. Likewise, the second end plate 306 and each bipolar plate, as represented by bipolar plate 312-m, comprise an input cathode flow port 324 and an output cathode flow port 326. Explicit cathode and anode slurry connections between plates and between the plates and reservoirs are not shown in FIG. 3A.

As shown in FIG. 3B, the anode slurry reservoir 128 and the plurality of anode compartments (302 and 318-m) are connected in series. The cathode slurry reservoir 130 and the plurality of cathode compartments (308 and 318-m) are connected in series. Alternatively but not shown, the anode slurry reservoir and the plurality of anode compartments may connected in parallel, in a manner similar to FIG. 2B. Likewise, the cathode slurry reservoir and the plurality of cathode compartments may be connected in parallel, as in FIG. 2B.

FIGS. 4A through 4H are exemplary detailed depictions of the plates of FIG. 3B. In FIG. 4A the sides of the first end plate 300 are labeled. as A and B. the sides of the bipolar plate 312-m are labeled C and D, and the sides of the second end plate 306 are labeled E and F. FIG. 4B depicts plan views of sides A and B, identifying the anode input port 320 (3), anode output port 322 (2), and anode compartment 302. FIG. 4C depicts plan views of sides C and D, identifying anode input port 320 (6), anode output port 322 (8), cathode input port 324 (5), cathode output port 326 (7), anode compartment 316-m, and cathode compartment 318-m. FIG. 4D depicts plan views of sides E and F, identifying cathode input port 324 (12), cathode output port 326 (10), and cathode compartment 308.

FIGS. 4E, 4F, and 4G are partial cross-sectional views of, respectively, the anode input port 320 (3), cathode past-through chamber 400 (1), and anode output port 322 (2) of the first end plate. Cross-sectional views of the second end plate are similar and are not shown in the interest of brevity. FIG. 4H is a partial cross-sectional view of cathode input port 324 (5) of the bipolar plate. Note, the designation of the various slurry ports as input and output ports is arbitrary. it should also be noted that the anode slurry flow need not necessary be in the same direction as the cathode slurry flow.

FIGS. 5A and 5B are partial cross-sectional views of a plurality of cells electrically connected in parallel. A first plurality of sequential electrically conductive anode plates 500-0 through 500-p are shown (p is an integer>1). Each of anode plates 500-0 through 500-p comprise an anode compartment. Shown is anode compartment 502-1. There is also a first plurality of sequential cathode plates 504-0 through 504-p, each comprising a cathode compartment. Shown is cathode compartment 506-1. A first plurality of OH⁻ anion exchange membranes are used, each Off anion exchange membrane respectively interposed between an associated pair of anode and cathode plates. Shown is OH⁻ anion exchange membrane 508-1.

Each of the anode plates 500-0 through 500-p comprises an anode input flow port and an anode output flow port. Shown are the input flow port 510 for anode plate 500-0 and the output flow port 512 for anode plate 500-p. Individual input and output ports for each anode plate are not shown, but their enablement would be relatively simple as compared to the plates of FIGS. 4A through 4H. Each of the cathode plates 504-0 through 504-p comprises an input cathode flow port and an output cathode flow port. Shown are the input flow port 514 for cathode plate 504-0 and the output flow port 516 for cathode plate 504-p. The anode slurry reservoir 128 is connected in series (slurry-wise) to the plurality of anode compartments. The cathode slurry reservoir 130 is connected is series (slurry-wise) with the plurality of cathode compartments. Alternatively but not shown, the slurry reservoirs may be connected in parallel, similar to the configuration of FIG. 2B.

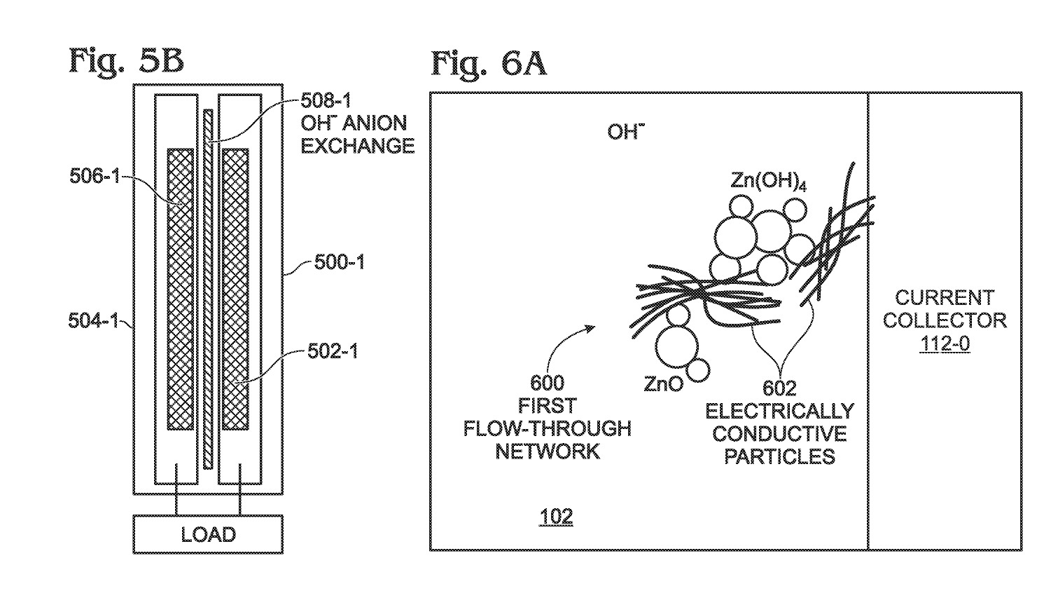

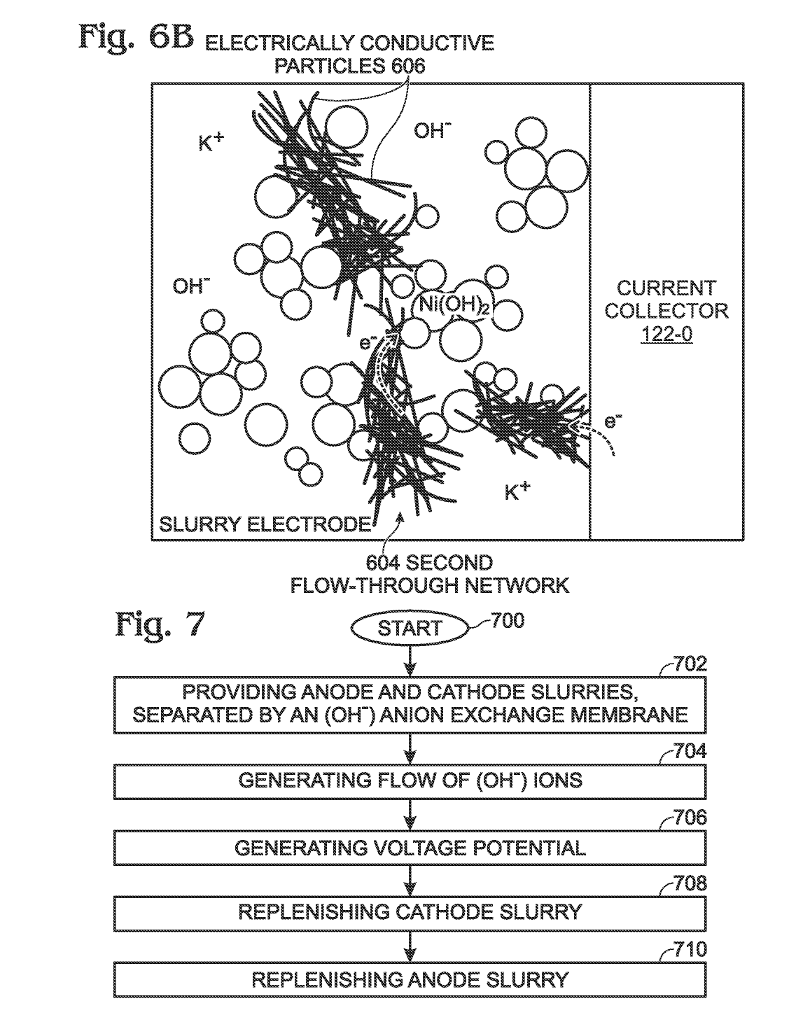

FIGS. 6A and 6B are diagrams respectively depicting details of the anode and cathode current collectors of FIG. 2A or 2B. In one aspect (FIG. 6A), a first flow-dynamic current collector network 600, including electrically conductive particles 602, is formed in the anode slurry 102 and is electrically connected to the first stationary current collector 112-0. Likewise, as depicted in FIG. 6B, a second flow-dynamic current collector network 604 includes electrically conductive particles 606 formed in the cathode slurry 104 and is electrically connected to the second stationary current collector 122-0. As explained in more detail below, the electrically conductive particles 602 and 606 are additives, such as a carbon material, added to the slurries to increase conductivity. Additives serve to enhance electronic conductivity through the slurry and some additives are used to suppress side reactions (usually undesirable) that produce oxygen and/or hydrogen gases.

With regards to electrical conductivity, the role of additives is important in slurry cathodes or anodes considering that the slurry has a relatively large amount of water content, as compared to a conventional solid cathode or anode. Conductive additives, such as carboneceous materials (e.g., carbon black, graphite, carbon fibers, and carbon. nanotubes) and metal powders, form a network of paths through which electrons can pass. Without these paths, electron conduction may be negligible, limiting chemical reaction before an appreciable amount of active material can be used. Limited chemical reactions result in low making the battery less practical.

Also, the morphology of additives is of interest. For example, in one experiment, the utilization of slurry with 10% weight of graphite particles was only 6%, whereas slurry with same % weight of carbon fiber was 40%. This result occurs because the shape of the conductive additives (e.g., carbon fibers) permits more connectivity than graphite spherical particles.

With regards to the suppression of side reactions, some additives serving to suppress side reactions may also work well to enhance electron conductivity. One example is the oxides of cobalt that are typically used in commercial, nickel based batteries (Ni—MH, Ni—Cd, Ni—Zn).

Returning to FIG. 1, the flow-through battery 100 )includes a slurry-type anode 102 and slurry-type cathode 104, separated by an ion exchange membrane 106. The anolyte 102 and catholyte 104 are circulated through the battery 100. The two compartments, anode 108 and cathode 118, are separated by the ion exchange membrane 106. When catholyte 104 and anolyte 102 pass through the compartments, electrochemical reactions take place at the electrodes. Through the ion exchange membrane 106, ions are transferred from one side to the other, realizing energy storage and conversion. A great deal of anolyte 102 and catholyte 104 can he stored, respectively, in the tanks 128 and 130. Auxiliary equipment (not shown) may be used to manage the slurry motion, heat generation, replenishment, and water balance during charge/discharge.

When the battery is assembled in its charged state, the slurry-type anolyte 102 consists of metal powder, electronic conductor, water, supporting salts, and additives. The metal may be, but not limited to be Mg, Al, Fe, Cu, Zn, etc. The catholyte 104 is a slurry containing oxidants, for example, NiOOH, MnO₂, or Fe(OH)₃. The composition of catholyte 104 can be similar to that of anolyte 102 except for active materials. In the slurry anolyte 102 and catholyte 104, the concentrations of active materials can be 0.1M to 50 M.

Examining a Zn—Ni FMB in the charged state as an example, the anolyte tank may include a zinc slurry with a KOH solution, and a NiOOH slurry may be included in the catholyte tank. When anolyte and catholyte are circulated through the compartments, the following reactions take place:

Anode: Zn+4OH⁻→Zn(OH)₄²⁻+2e⁻;

Zn(OH)₄²⁻→ZnO+H₂O+2OH⁻;

Cathode: NiOOH+H₂O+e⁻→Ni(OH)₂+OH⁻;

Overall reaction: Zn+2NiOOH+H₂O═ZnO+2Ni(OH)₂

Zn is oxidized to ZnO at the anode, and NiOOH is reduced to Ni(OH)₂ at the cathode. In order to generate electric power, electrons move from the anode to cathode along an external circuit, while OH⁻0 ions move from the cathode to the anode through the OH⁻-ions exchange membrane. The theoretical voltage for the Zn—Ni FMB is 1.73V.

When the batteries are assembled in their discharged state, the active materials for the anolyte can include metal oxides or hydroxides, and the catholyte may be a slurry containing reductants. The above-cited reactions occur in the reverse direction when the battery is charging.

During charge, OH⁻ ions move from the cathode to the anode. During discharge, the ions move from the anode to the cathode. Some examples of a charged-state battery are:

Zn anode—NiOOH cathode;

Fe anode—MnO₂ cathode;

Zn anode—Fe₂O₃ cathode.

In the discharged state, the above-listed batteries are as follows:

ZnO anode—Ni(OH)₂ cathode;

FeO anode—Mn₂O₃ cathode;

ZnO anode—Fe(OH)₂ cathode.

Thus, if the battery is assembled with a Zn anode and NiOOH cathode, it is in the charged state. When the battery is discharged, the cathode NiOOH obtains electrons to form Ni(OH)₂. In this case, the cathode is no longer a resource of electrons. If the battery is assembled in its discharge state, with a ZnO anode and a Ni(OH)₂ cathode, during charging Ni(OH)₂ loses electrons to form NiOOH. In this case, the cathode is a resource of electrons.

In order to obtain high voltage and high energy density, the battery can be connected in serial as shown in FIGS. 3A and 3B. The anode and cathode compartments (plates) may be made from materials with high electrical and thermal conductance, such as graphite and metal. The material is selected not to have a reaction with catholyte and anolyte. Because the plates are electrically conductive, series connections can be formed between neighboring cells. Every plate can be connected either in parallel or serial, slurry-wise, to circulate catholyte and anolyte.

With the battery of FIGS. 5A and 5B, the battery cells (associated pairs of anode and cathode plates) can be directly removed from the stack and used into portable devices. When the power of a battery cell is used up, it can be reconnected to the FMB stack and replenish with fresh catholyte and anolyte, which can realize a “fast” charge. in either series or parallel slurry-wise configurations, the whole battery pack can be quickly recharged by replacing the depleted catholyte and anolyte.

FIG. 7 is a flowchart illustrating method for forming a voltage potential across a flow-through battery. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 700.

Step 702 provides a battery with an anode slurry and a cathode slurry, separated by a hydroxide (OH⁻) anion exchange membrane. Some examples of flow-through batteries have been provided above. As also mentioned above, the anode slurry may comprise a metal, and associated oxides, of magnesium (Mg), aluminum (Al), iron (Fe), copper (Cu), or zinc (Zn). The cathode slurry may comprise a chemical agent such as nickel oxyhydroxide (NiOOH), nickel (II) hydroxide (Ni(OH)₂), manganese oxide (MnO₂), manganese (II) oxide (Mn₂O₃), iron (III) oxide (Fe₂O₃) iron (III) oxide (FeO), iron (III) hydroxide (Fe(OH)₃), or combinations of the above-referenced materials.

Step 704 generates a flow of (OH⁻) ions and electrons between the cathode slurry and the anode slurry in the battery. The direction of flow is dependent upon whether the battery is being charged or discharged. Step 706 generates a voltage potential across a load electrically connected between the anode slurry and the cathode slurry. In one aspect, Step 708 replenishes the cathode slurry from a cathode slurry reservoir, and Step 710 replenishes the anode slurry from an anode slurry reservoir.

In one aspect, providing the anode slurry and the cathode slurry in Step 702 includes providing anode and cathode slurries each comprising electrically conductive particles. Then, generating the flow of OH⁻ ions and electrons between the cathode slurry and the anode slurry in Step 704 includes forming flow-dynamic current collector networks in the anode and cathode slurries in response to the electrically conductive particles, as depicted in FIGS. 6A and 6B.

A flow-through battery has been provided along with an associated method for creating a voltage potential. Examples of materials and slurry flow configurations have been presented to illustrate the invention. However, the invention is not limited to merely these examples. Other variations and embodiments of the invention will occur to those skilled in the art.

We claim:

1. A metal flow-through battery with ion exchange membrane, the flow-through battery comprising:
an anode slurry;
a cathode slurry; and,
a hydroxide (OH⁻) anion exchange membrane interposed between the anode slurry and the cathode slurry.

2. The flow-through battery of claim 1 wherein the anode slurry includes a metal, and associated oxides, selected from a group consisting of magnesium (Mg), aluminum (Al), iron (Fe), copper (Cu), and zinc (Zn).

3. The flow-through battery of claim 1 wherein the cathode slurry includes a chemical agent selected from a group consisting of nickel oxyhydroxide (NiOOH), nickel (II) hydroxide (Ni(OH)₂), manganese oxide (MnO₂), manganese (II) oxide (Mn₂O₃), iron (III) oxide (Fe₂O₃), iron (III) oxide (FeO), iron (III) hydroxide (Fe(OH)₃), and combinations of the above-referenced materials.

4. The flow-through battery of claim 1 wherein the anode and cathode slurries are aqueous slurries.

5. The flow-through battery of claim 1 wherein the flow-through battery is completely charged and discharged in a voltage potential range of 0 to 2.5 volts

6. The flow-through battery of claim 2 wherein the anode slurry additionally includes potassium hydroxide (KOH); and,
wherein the cathode slurry includes KOH and a chemical agent selected from a group consisting of NiOOH, MnO₂, Fe₂O₃, Ni(OH)₂, Mn₂O₃, FeO, Fe(OH)₃, and combinations of the above-referenced materials.

7. The flow-through battery of claim 1 further comprising:
an anode compartment with an anion exchange membrane interface, a first stationary current collector, an input flow port, and an output flow port;
a cathode compartment with an anion exchange membrane interface, a second stationary current collector, an input flow port, and an output flow port;
an anode slurry reservoir connected to the input and output flow ports of the anode compartment; and,
a cathode slurry reservoir connected to the input and output flow ports of the cathode compartment.

8. The flow-through battery of claim 1 further comprising:
a plurality of cells, where each cell includes an anode slurry and a cathode slurry, and where the plurality of cells are connected in a configuration selected from a group consisting of series and parallel electrical connections.

9. The flow-through battery of claim 8 wherein each cell further comprising:
an anode compartment with an anion exchange membrane interface, a first stationary current collector, an input flow port, and an output flow port;
a cathode compartment with an anion exchange membrane interface, a second stationary current collector, an input flow port, and an output flow port;
an anode slurry reservoir;
a cathode slurry reservoir;
wherein the anode slurry reservoir and the plurality of anode compartments are connected in series; and,
wherein the cathode slurry reservoir and the plurality of cathode compartments are connected in series.

10. The flow-through battery of claim 8 wherein the plurality of cells are electrically connected in series;
the flow-through battery further comprising:
a plurality of sequential plates comprising:
an electrically conductive first end plate with an anode compartment;
an electrically conductive second end plate with a cathode compartment;
at least one electrically conductive bipolar plate configured between the first and second end plates, each bipolar plate comprising a first side with an anode compartment and a second side with a cathode compartment; and,
an OH⁻ anion exchange membrane interposed between. each plate.

11. The flow-through battery of claim 10 wherein the first end plate and each bipolar plate comprise an anode input flow port and an anode output flow port;
wherein the second end plate and each bipolar plate comprise an input cathode flow port and an output cathode flow port;
the flow-through battery further comprising:
an anode slurry reservoir;
a cathode slurry reservoir;
wherein the anode slurry reservoir and the plurality of anode compartments are connected in series; and,
wherein the cathode slurry reservoir and the plurality of cathode compartments are connected in series.

12. The flow-through battery of claim 8 wherein the plurality of cells are electrically connected in parallel;
the flow-through battery further comprising:
a first plurality of sequential electrically conductive anode plates, each anode plate comprising an anode compartment;
a first plurality of sequential electrically conductive cathode plates, each cathode plate comprising a cathode compartment;
a first plurality of OH⁻ anion exchange membranes, each OH⁻ anion exchange membrane interposed between an associated pair of anode and cathode plates.

13. The flow-through battery of claim 12 wherein each anode plate comprises an anode input flow port and an anode output flow port;
wherein each cathode plate comprises an input cathode flow port and an output cathode flow port;
the flow-through battery further comprising:
an anode slurry reservoir;
a cathode slurry reservoir;
wherein the anode slurry reservoir and the plurality of anode compartments are connected in series; and,
wherein the cathode slurry reservoir and the plurality of cathode compartments are connected in series.

14. The flow-through battery of claim 7 further comprising:
a first flow-dynamic current collector network, including electrically conductive particles, formed in the anode slurry and electrically connected to the first stationary current collector; and,
a second flow-dynamic current collector network, including electrically conductive particles, formed in the cathode slurry and electrically connected to the second stationary current collector.

15. A method for forming a voltage potential across a flow-through battery, the method comprising:
providing a battery with an anode slurry and a cathode slurry, separated by a hydroxide (OH⁻) anion exchange membrane;
generating a flow of OH⁻ ions and electrons between the cathode slurry and the anode slurry in the battery; and,
generating a voltage potential across a load electrically connected between the anode slurry and the cathode slurry.

16. The method of claim 15 further comprising:
replenishing the cathode slurry from a cathode slurry reservoir; and,
replenishing the anode slurry from an anode slurry reservoir.

17. The method of claim 15 wherein providing the anode slurry includes providing an anode slurry comprising a metal, and associated oxides, selected from a group consisting of magnesium (Mg), aluminum (Al), iron (Fe), copper (Cu), and zinc (Zn).

18. The method of claim 15 wherein providing the cathode slurry includes providing a cathode slurry comprising a chemical agent selected from a group consisting of nickel oxyhydroxide (NiOOH), nickel (II) hydroxide (Ni(OH)₂), manganese oxide (MnO₂), manganese (II) oxide (Mn₂O₃), iron (III) oxide (Fe₂O₃), iron (III) oxide (FeO), iron (III) hydroxide (Fe(OH)₃), and combinations of the above-referenced materials.

19. The method of claim 15 wherein providing the anode slurry and the cathode slurry includes providing anode and cathode slurries each comprising electrically conductive particles; and,
wherein generating the flow of OH⁻ ions and electrons between the cathode slurry and the anode slurry includes forming flow-dynamic current collector networks in the anode and cathode slurries in response to the electrically conductive particles.
